(19) United States
(12) Patent Application Publication
(10) Pub. No.: US 2008/0291050 A1
(43) Pub. Date: Nov. 27, 2008

(54) Wildlife alert system

(76) Inventors: Kerry Lebreton, Sudbury (CA); Robert Chaput, Garson (CA)

Correspondence Address: MIKE GAUTHIER, 355 GOODWILL DRIVE, BOX 400, GARSON, ON, P3L 1S7, CA

(21) Appl. No.: 11/802,603

(22) Filed: May 24, 2007

(51) Int. Cl. G08G 1/16

(52) U.S. Cl. 340/901; 340/600

(57) ABSTRACT

A system for alerting a driver of the presence of wildlife on the road ahead. The system logically deciphers between animal heat and the heat of an oncoming vehicle by way of a combination of infrared (IR) and photo sensors and an AND/NOT logic. At night—when wildlife is not easily visible—the infrared sensor can detect the presence of wildlife and alert the driver both visually and audibly, and if an oncoming vehicle is present with its lights turned on, the alarm is ignored. If wildlife is present and no lighted vehicle is present, then the visual and audible alarm sounds.

### FIELD OF THE INVENTION

The present invention relates to system for alerting a driver of the presence of wildlife on the road ahead. The system logically deciphers between animal heat and the heat of an oncoming vehicle by way of a combination of infrared (IR) and photo sensors and an AND/NOT logic. At night—when wildlife is not easily visible—the infrared sensor can detect the presence of wildlife and alert the driver both visually and audibly, and if an oncoming vehicle is present with its lights turned on, the alarm is ignored. If wildlife is present and no lighted vehicle is present, then the visual and audible alarm sounds.

### BACKGROUND OF THE INVENTION

Long distance travel is commonplace, and nighttime dangers are increased by the presence of and difficulties in seeing wildlife. Many are killed or severely injured by collisions with wildlife.

Although IR sensors have been used in the past for the detection of heated objects, these have not been successful in deciphering between animals and vehicles.

Through the inventive process, the applicants needed to ensure that such a system could indeed exclude vehicles' heat from its logic, and by utilizing the AND/NOT logic of the present invention, the inventors were able to alarm drivers of animal presence and exclude vehicles.

What was achieved was a logical function that enables the use of an IR sensor for heat detection and a photo sensor for determination of a vehicle having it's lights turned on. In addition, a second photo sensor gathers ambient exterior lighting to determine weather in it daytime or nighttime, thus disabling the IR sensor so as to not achieve false-positive reading. Additionally, an exterior temperature sensor is placed in the logic to determine temperature differences between animal presence and the ambient temperature.

The applicant is aware of attempts in prior art to provide means of detecting or deterring wildlife.

An example may be had by referring to prior art U.S. Pat. No. 5,969,593 of Will, issued Oct. 19, 1999 depicting a warning system in combination with a vehicle in which ultrasonic sound and ultraviolet is beamed in advance of the moving vehicle on a thoroughfare so that said sound and light may be heard and seen by an animal ahead of the moving vehicle to induce the animal to leave the road before it is struck by the vehicle.

The above system functions in contrary to animal behavioral patterns in that, animals in the bush along the road may be curious as to the source of the interesting sound and light and may venture onto the road ahead of the moving vehicle in order to satisfy their curiosity. Furthermore, wild animals have a historical tendency to “freeze” upon the notice of bright lights.

Another example of prior art may be had in referring to U.S. Pat. No. 7,098,775 of Perlo et al., issued Aug. 29, 2006, which teaches of a system and method that avoids the collision of a vehicle with animals tending to cross the road before the moving vehicle. The system comprising a visual system directly actuating one or more RF emitters, emitting directional sound waves with a frequency above 25 KHz. Sound waves are directed frontally through with a frequency decreasing from the center of the roadway toward the road edge, so as to lead the animal to move towards the road edge.

The above system and method fails to alert the driver of the presence of animals on the road ahead.

While attempts in prior art have been made to provide drivers with alarm, lights, sounds that alert drivers of animals on the road ahead, or induce animals to leave the road, none thus far provide the benefits of the present invention.

### SUMMARY OF THE INVENTION

It is thus the object of the present invention to provide drivers with a system for alerting of the presence of animals, using IR and photo sensing, which deciphers between animal and artificial heat.

In one aspect of the invention, the system is adapted with UF sound emission for chasing-away detected animals.

In another aspect of the invention, the system may be adapted for new production or aftermarket vehicles.

Accordingly, the system of the present invention provides drivers with a system for alerting of the presence of animals, using IR and photo sensing, which deciphers between animal and artificial heat.

While the invention is embodied in a car, the utility of the invention includes but is not limited to car.

### BRIEF DESCRIPTION OF THE DRAWINGS

These and other advantages of the invention will become apparent upon reading the following detailed description and upon referring to the drawings in which:—

FIG. 1 is a view from a vehicle's windshield of a scenario of the present invention.

FIG. 2 is a flow chart depicting the logic in the scenario of FIG. 1.

FIG. 3 is a view from a vehicle's windshield of a scenario of the present invention.

FIG. 4 is a flow chart depicting the logic in the scenario of FIG. 3.

FIG. 5 is a view from a vehicle's windshield of a scenario of the present invention.

FIG. 6 is a flow chart depicting the logic in the scenario of FIG. 5.

FIG. 7 is a view from a vehicle's windshield of a scenario of the present invention.

FIG. 8 is a flow chart depicting the logic in the scenario of FIG. 7.

FIG. 9 is a view from a vehicle's windshield of a scenario of the present invention.

FIG. 10 is a flow chart depicting the logic in the scenario of FIG. 9.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

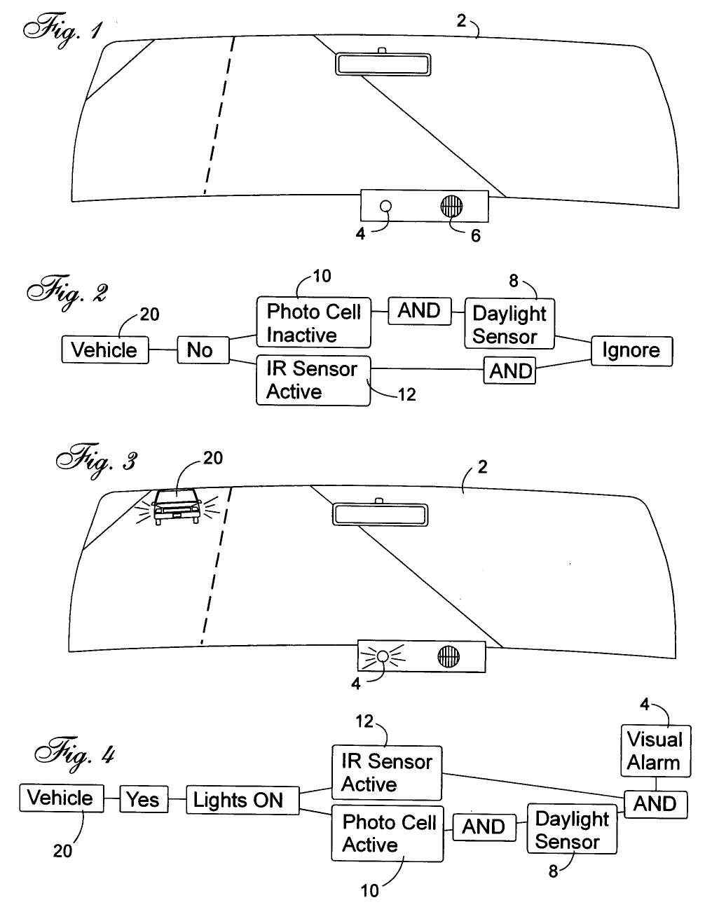

Turning to the drawings, in particular, FIGS. 1 and 2, which FIG. 1 illustrates a view from a vehicle's windshield 2 of a scenario where no vehicle or animal is present in daylight, and FIG. 2, a flow chart depicting the logic used in the scenario of FIG. 1 wherein, a daylight sensor 8 identifies daylight, causing the system to be fooled by the presence of bright light, which could otherwise be mistaken for a vehicle's 20 headlights. However, the primary photo sensor 10 is seeking high intensity light, which will be entered into the logic sequence, day or night. Although some will argue that animals are clearly visible in daylight, the premise behind this feature is simply to enable the system to always monitor for the presence of animals on the road ahead of a moving vehicle. Therefore, the system is also adapted with a speed actuation portion in the logic wherein the system is totally disabled when the vehicle slows to below a defined speed, say, 20 miles per hour for instance. In this scenario, no obstructions are found on the road ahead. The visual and audible alarms 4 and 6 respectively are disabled. No road hazard is present.

Referring now to FIGS. 3 and 4, wherein FIG. 3 illustrates a view from a vehicle's windshield 2 of another scenario where only an oncoming vehicle 20 is present on the road ahead in daylight, and FIG. 4 a flow chart depicting the logic of this scenario. An oncoming vehicle 20 approaches, triggering the IR sensor 12. In daylight the daylight sensor 8 is also triggered, and while most vehicles today have daytime running lights, so is the first photo sensor 10 triggered. Since in daylight, animals are much easier seen, the combination of the first photo sensor 10, the second photo sensor 8 and the IR sensor tells the system to enable only the visual alert 4 and not the audible alert 6.

Turning now to FIGS. 5 and 6, wherein FIG. 5 is a view from a windshield 2 of another scenario where only an oncoming vehicle 20 is present on the road ahead at night, a FIG. 6, a flow chart depicting the logic used in the scenario of FIG. 5. In this scenario, it is dark out, and an oncoming vehicle 20 approaches. The vehicle's 20 lights are on, triggering the first photo sensor 10, yet the daylight sensor is not triggered. The vehicle's 20 heat triggers the IR sensor 12. Therefore, this combination makes no alert to the driver since the driver easily sees the oncoming vehicle's 20 lights.

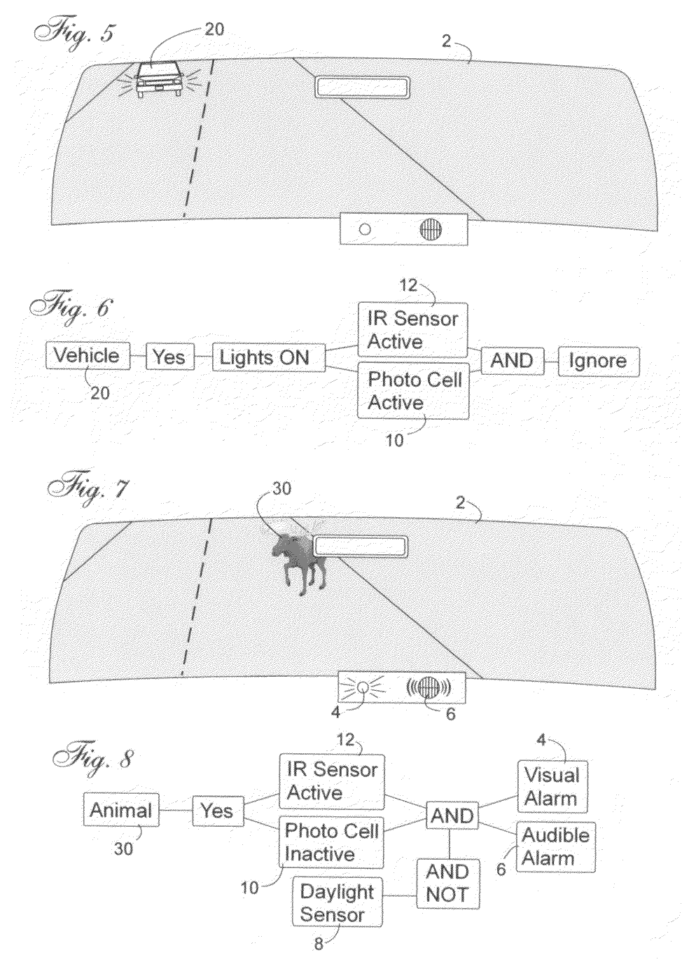

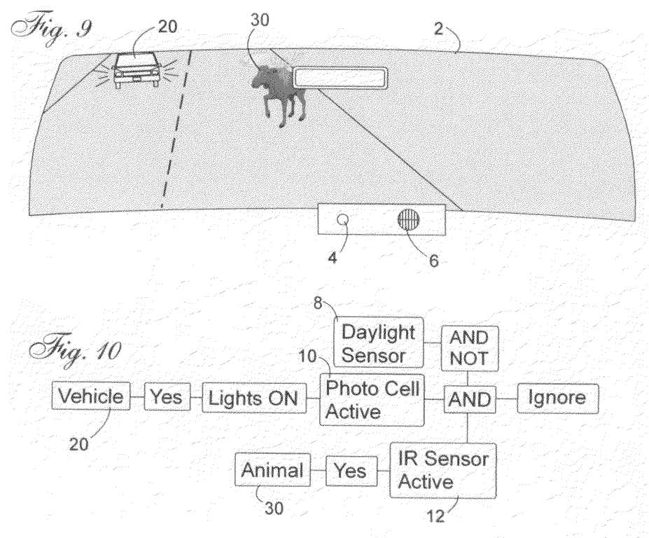

Referring now to FIGS. 7 and 8, wherein FIG. 7 is a view from a windshield 2 of yet another scenario where only an animal is present on the road ahead of the vehicle 20 at nighttime, and FIG. 8 is a flow chart depicting the logic used in the scenario of FIG. 7. The heat of the animal 30 on the road ahead of the vehicle 20 triggers the IR sensor 12 while the lack of light leaves the photo sensor 10 inactive. This combination results in a clear indication that there is a high likelihood of an animal 30 ahead thus sounding the audible alarm 6 and activating the visual alert 4. There is danger ahead and the driver is given plenty of notice to slow the vehicle to a safe speed in order to divert the animal 30.

Now referring to FIGS. 9 and 10, wherein FIG. 9 is yet again a view from a windshield 2 at night of a last scenario where both an oncoming vehicle 20 and an animal 30 are present on the road ahead on the vehicle 20, and FIG. 10 depicts the logic used for this scenario of FIG. 9. In this scenario, it is nighttime and only an animal 30 is present on the road ahead of the vehicle 20. The IR sensor 12 is triggered and both the daylight and photo sensors 8 & 10 are inactive. This logic tells the system that an animal may be present ahead but the oncoming vehicle 20 will backlight the animal 30 and thus the system ignores the event since it is likely the driver will see the animal 30.

The chart below further simplifies the logic used by the system of the present invention:

| | | | | | | | | | |
|---|---|---|---|---|---|---|---|---|---|
| Sensors | Photo | 0 | 0 | 0 | 1 | 1 | 1 | 1 | 0 |
| | Daylight | 0 | 0 | 1 | 0 | 0 | 1 | 1 | 1 |
| | IR | 0 | 1 | 1 | 0 | 1 | 0 | 1 | 0 |
| | ALARMS | NO | AU | NO | NO | NO | NO | NO | NO |
| | | NO | VIS | VIS | NO | NO | NO | NO | NO |

| | | |
|---|---|---|
| Sensor | Active | 1 |
| Status | Inactive | 0 |

AU = Audible
VIS = Visual
NO = No Alarm

Therefore, drivers utilizing the system of the present invention can now be alerted of animal and vehicle hazards without having to compensate or decipher alerts of such hazards day or night.

1. An wildlife alert system comprising:
a. a first photo sensor,
b. a daylight photo sensor,
c. an infrared sensor,
d. a speed sensor,
e. a logical sequence for determining events
f. an audible alarm, and
g. a visual alarm.

2. The wildlife alert system of claim 1 wherein the first photo sensor is positioned so as it can sense frontwardly ahead of a vehicle, and is calibrated to detect light density greater than ambient daylight.

3. The wildlife alert system of claim 1 wherein the daylight photo sensor is arranged to be shielded from intense light, and is calibrated to detect only soft ambient lighting.

4. The wildlife alert system of claim 1 wherein the infrared sensor is arranged to collect infrared waves from the path ahead of a moving vehicle.

5. The wildlife alert system of claim 1 wherein data from the sensors are fed into a logic sequence to determine the status of audible and visual alarms.

6. The wildlife alert system of claim 1 wherein the system logically deciphers between animal heat and the heat of an oncoming vehicle by way of a combination of infrared and photo sensors and an AND/NOT logic.

7. The wildlife alert system of claim 1 wherein the visual alarm is activated when the infrared sensor is triggered.

8. The wildlife alert system of claim wherein the audible and the visual alarms are activated when the daylight and the infrared sensors are triggered.

9. The wildlife alert system of claim 1 wherein the speed sensor is engaged to the vehicle's power train.

10. The wildlife alert system of claim wherein the speed sensor is adapted with a speed threshold setting feature.

11. The wildlife alert system of claim 1 wherein the wildlife alert system in activated only when the vehicle adapted with the present invention is moving beyond a preset speed threshold.

12. The wildlife alert system of claim 1 wherein the visual alarm in mounted so as to reflect light onto the angled windshield to be visible by the driver.

13. The wildlife alert system of claim 1 wherein the first photo sensor, the daylight sensor and the infrared sensor are mounted inconspicuously within a front portion of the adapted vehicle.
